(19) United States
(12) Patent Application Publication
(10) Pub. No.: US 2004/0142615 A1
(43) Pub. Date: Jul. 22, 2004

(54) Method for forming a soil-resistant, stain-concealing fabric and apparel formed therefrom

(76) Inventors: Joy S. Hatch, Wilmington, NC (US); Wayne E. Whitney, Lumberton, NC (US)

Correspondence Address: WOMBLE CARLYLE SANDRIDGE & RICE, PLLC, P.O. BOX 7037, ATLANTA, GA, 30357-0037, US

(21) Appl. No.: 10/346,645

(22) Filed: Jan. 17, 2003

(51) Int. Cl. B32B 27/04

(52) U.S. Cl. 442/93

(57) ABSTRACT

A soil-releasing, stain-concealing apparel made from a fabric comprising natural and synthetic materials, or blends thereof. The fabric is cross-dyed with two colors, at least one of which is a stain-conforming color. The fabric is also treated with a soil release agent.

### FIELD OF THE INVENTION

The present invention relates to the field of textile treatment and finishing, and, more particularly to a method for forming a stain-resistant and stain-concealing knitted fabric, and articles of apparel formed therefrom.

### BACKGROUND OF THE INVENTION

In recent years, apparel formed substantially from cotton blended with synthetic yams has become increasing popular in the manufacture of outwear, such as golf shirts and sportswear. Cotton blends, however, tend to stain easily and retain the stains. Even after a substantial number of home launderings, the stains are often not removed completely.

Manufacturers have sought more efficient and cost-effective ways for producing blended knitted apparel that have resistance or repellency to common staining materials. As a result, a number of chemical finishes and treatments have been developed. In fact, most advances in the art have been directed to specific chemical formulations that are hoped to enhance soil resistance and release.

There are known both soil, or stain “resist” agents, and stain “release” agents. The stain resist finishes serve primarily to coat the outer surface areas of fibers and yams; however, they suffer from a lack of durability and wear off after only a few home launderings. Stain release agents, on the other hand, provide some penetration into the fibers of the yarns, but much of the finish is lost during the curing process as the release agents are driven out of the fiber through thermal migration at high curing temperatures. Nonetheless, stain release agents have, in many applications, exhibited greater durability after repeated home launderings than stain resist agents. Even with stain release agents, however, all of the stain is not removed, and residual staining remains in the apparel. When worn in commercial applications, such as restaurant services, automotive services, or other service industries where contact with dirt and oily products is expected, garments quickly become unsightly, and thus, unserviceable. For example, restaurant workers frequently encounter staining through contacts with food products such as vegetable oil, mustard, catsup, etc.

Notwithstanding the above difficulties, many of the commercially popular stain resist and stain release agents are also fluorochemical-based products. Fluorochemicals pose a number of problems to textile manufacturers. They are potentially hazardous and environmentally problematic, and they do not provide ultimate wear characteristics, e.g., wicking.

### SUMMARY OF THE INVENTION

The present invention is directed to a method for producing a knitted fabric, or items of apparel, having a high level of stain release, and an ability to conceal residual stains trapped within the fibers and yams of the fabric.

One aspect of the invention is a method for forming a soil-releasing, stain-concealing, fabric, and apparel formed from the fabric. The fabric is formed of natural and synthetic materials, which may include yams of polyester and cotton, or intimate blends thereof. In a preferred embodiment, the fabric is knitted from polyester and cotton materials where the polyester comprises at least about 60 percent by weight of the fabric construction. It has also been found that certain knitted fabric patterns, such as box stitches and stripes, contribute to the level of stain-concealment in the final fabric or item of apparel.

As a first step in the finishing process, the knitted fabric is cross-dyed with two selected colors to create unique contrasting color patterns based on the different affinities that the cotton and polyester have for dyes. As is well known in the art, cross-dyeing is a method of dyeing blend or combination fabrics to two or more shades by the use of dyes having different affinities for the different fibers or yams. It has been found that certain contrasting color patterns provide a high level of stain-concealment, or camouflage, to the finished fabric. At least one of the colors is a stain-conforming color. This means that the color provides a high level of concealment of, or blends with, stains that a user might expect to encounter; e.g., dirt, oils, foods such as catsup and mustard, etc. Desirably, during the cross-dyeing operation, a non-fluorochemical soil release agent is also applied to the fabric.

The cross-dyed and treated fabric is folded and predried before being heated under a conventional finishing range where additional chemical finishes (softeners, and the like) may be applied. The fabric is substantially dried within a desired temperature range of between about 225° F. and 275° F. The drying temperature, which is lower than the average curing temperature of 300° F., allows for even penetration and drying of the of the chemicals, particularly the soil release agent, without creating thermal migration of the soil release agent, and any other chemical finishes, out of the internal polyester fibers. Further, this temperature is low enough that final curing does not occur.

After the finishes have been applied and dried, the fabric is subjected to a curing range where the finished fabric is cured at a temperature of between about 285° F. and 325° F. This is substantially different from the conventional methods that apply and cure soil release agents or chemical finishes in a single step. As a result, the final treated fabric has a substantially more durable, longer lasting, and penetrating soil release finish than the finish obtained with the conventional one step method.

The final fabric or apparel of the present invention exhibits a high level of soil release and stain camouflage for a range of contrasting color patterns, when finished in accordance with the present invention. When measured in accordance with the test scale of the American Association of Textile Chemists and Colorists (AATCC), Test Method 130-2000: Oily Stain Release Method, low ratings were measured. AATCC Test Method 130 is a standard test method that is designed to measure the ability of fabrics to release oily stains during home laundering. The inventors have also found that the test scale is quite applicable to measuring the level of staining appearance for dyed and treated fabrics; i.e., since the test scale is a visual one, factors such the fabric pattern and fabric colors also affect the visual rating of residual staining on fabric samples. Applying the AATCC Standard 130, stained fabric is laundered in a prescribed manner and the residual stain is rated on a scale from 1 to 5 by comparison with a stain release replica. A rating of 1 means that little or no stain has been released, and a rating of 5 means that substantially all of the stain has been released.

Additionally, because the knitted fabric has been finished with a soil release which is hydrophilic, the finished fabric exhibits high levels of wicking, which is highly desirable for apparel made for use as uniforms or other commercial garments which are worn in contact with the skin.

These and other aspects of the present invention will become apparent to those skilled in the art after a reading of the following description of the preferred embodiments when considered in conjunction with the drawings. It should be understood that both the foregoing general description and the following detailed description are exemplary and explanatory only and are not restrictive of the invention as claimed.

### BRIEF DESCRIPTION OF THE DRAWINGS

FIG. 1 is a flow diagram of the method of the present invention;

FIG. 2 is a table of stain-conforming colors used for cross-dyeing the fabric of the present invention;

FIGS. 3 through 7 illustrate the results of measurements performed in accordance with AATCC Test Method 130-2000 on fabric formed according to the present invention; and

FIG. 8 illustrates the results of vertical wicking testing performed on fabric formed according to the present invention.

### DETAILED DESCRIPTION OF THE PREFERRED EMBODIMENTS

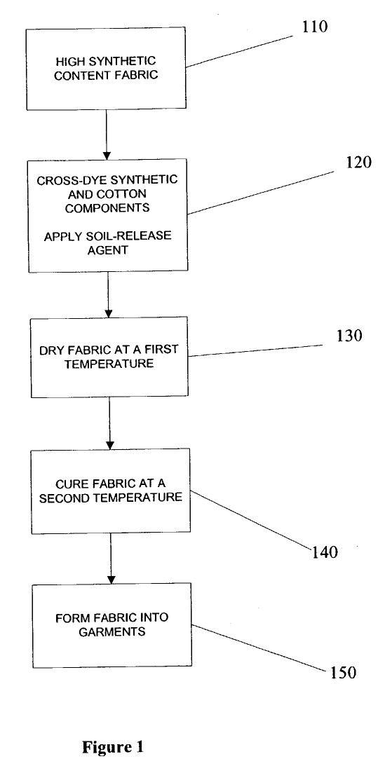

As illustrated in FIG. 1, the present invention is directed to a method for forming a high soil-releasing, high stain-concealing, fabric and apparel formed from the fabric, where the fabric has a high content of synthetic materials. “Soil” refers to dirt, oil, or other substances not normally intended to be present on a substrate such as a textile. “Stain” as used herein, refers to a local deposit of soil or discoloration on a textile fabric that exhibits some degree of resistance to removal, as by laundering or dry cleaning. As used herein, the term “soil release” refers to the degree to which a soiled substrate approaches its original unsoiled appearance as a result of a treatment process. The terms “soil-concealing,” “soil-conforming,” and “stain conforming” are used interchangeably to refer to the degree to which any residual stain on a textile blends in with the pattern and/or colors of the textile.

In one embodiment of the present invention, the fabric is knitted and formed of at least about 60% by weight polyester material, and about 40% or less by weight cotton. A preferred embodiment is 75% polyester and 25% cotton. The present invention, however, is not limited to a particular knitted fabric construction, so long as the overall fabric construction is substantially synthetic (Step 110). Further, the polyester and cotton components used to form the knitted fabric may be comprised of polyester and cotton yams or intimate blends thereof.

It has been found that certain knitted constructions contribute to the ability of the fabric to conceal, or camouflage, stains. While not limited to these constructions, the following constructions are exemplary of those found most suitable. As those skilled in the art will appreciate, the fabric constructions described herein may be formed on any number of makes and models of knitting machines, and may be formed with varying knitting head diameters.

### EXAMPLE 1

This fabric is a piece dye cotton and spun polyester boxstitch. The fabric is knitted on a Model DXC-45 circular knitting machine, available from Monarch Knitting Machinery Corporation. The machine knitting head diameter is 19 inches and comprises 1,296 needles, 76 feeds, and runs at 44.3 rpm. The yarn counts comprise 75% by weight 18/1 natural spun polyester and 25% by weight 18/1 combed ring spun cotton. The fabric is knitted with 41 courses and 22 wales to yield a fabric having a finished course count of 44, a finished wale count of 28, and a finished weight of 7.33 ounces per square yard.

### EXAMPLE 2

This fabric is a 4×4 piece dye polyester and cotton lacoste stripe. The fabric is knitted on a Model XL45 circular knitting machine, available from Monarch Knitting Machinery Corporation. The machine knitting head diameter is 26 inches and comprises 1,620 needles, 104 feeds, and runs at 23 rpm. The yarn counts comprise 50% by weight, 20/1, 50/50 air jet spun polyester and cotton, and 50% by weight natural spun polyester. The fabric is knitted with 40 courses and 21 wales to yield a fabric having a finished course count of 41, a finished wale count of 27, and a finished weight of 6.6 ounces per square yard.

### EXAMPLE 3

This fabric is a piece dye jacquard herringbone. The fabric is knitted on a Model FXC-45 circular knitting machine, available from Monarch Knitting Machinery Corporation. The machine knitting head diameter is 26 inches and comprises 1,620 needles, 102 feeds, and runs at 26 rpm. The yarn counts comprise 50% by weight 20/1, 50/50 air jet spun polyester and cotton, and 50% by weight 18/1 natural spun polyester. The fabric is knitted with 33 courses and 21 wales to yield a fabric having a finished course count of 40, a finished wale count of 28, and a finished weight of 7.1 ounces per square yard.

### EXAMPLE 4

This fabric is a piece dye jersey end-on-end stripe. The fabric is knitted on the XL-45 machine with a 26 inch diameter head, 1,800 needles, 104 feeds, and runs at 26 rpm. The yarn counts comprise 50% by weight 20/1, 50/50 air jet spun polyester and cotton, and 50% by weight 18/1 natural spun polyester. The fabric is knitted with 39 courses and 26 wales to yield a fabric having a finished course count of 41, a finished wale count of 30, and a finished weight of 5.6 ounces per square yard.

Once the knitted fabric has been formed, it is ready for dyeing and finishing (Step 120). The dyeing process is cross-dyeing. As is known in the art, cross-dyeing is a method of dyeing a blend or combination fabrics to two or more shades by the use of dyes having different affinities for the different fibers or yarns. The fabric is first immersed in a polyester dye bath whereby the polyester component of the fabric is dyed with high-energy disperse dyes. There are a number of suitable suppliers for these dyes. A non-flourchemical, hydrophilic polyester soil-release agent may be added to the dye bath to impart soil-release qualities to the finished fabric, and apparel formed therefrom. It has been found that a 40 to 50 minute hold time at a temperature of between about 265 and 275 degrees Fahrenheit imparts optimal dyeing and soil-release properties to the knitted fabric. A soil-release agent found quite suitable is a 4 percent to 6 percent solution of Pomoco SRE 60, available from Piedmont Chemical Industries of High Point, N.C. Pomoco SRE 60 has been found to provide a durable finish, good soil release, and as will be discussed below, good wicking properties to the fabric constructions of the present invention. As those skilled in the art will appreciate, the chemical agents and suppliers listed herein are not intended to limit the invention thereto.

Following the polyester dye bath, the knitted fabric is immersed in a cotton dye bath where the cotton component of the knitted fabric is dyed with reactive dyes. There are also several suitable suppliers for such dyes. The time that the knitted fabric remains in the dye bath for these dyes is dependent on the selected color.

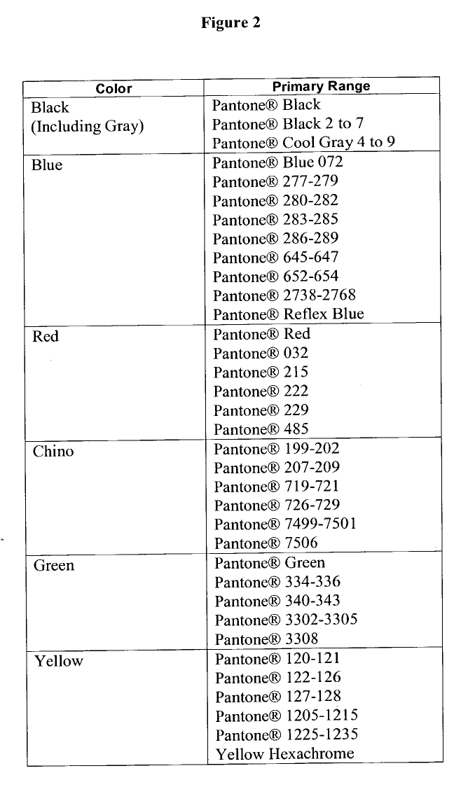

As will be discussed in greater detail below, certain colors and color combinations have been found more suitable for the stain-concealing and stain-conforming properties of the final fabric and apparel. It has been found that at least one of the two colors (polyester or cotton) should be a stain-conforming color that provides a suitable level of concealment and blending with the types of stains that a wearer of the apparel might encounter; e.g., vegetable oil, animal fat, mustard, catsup, etc. Some of the colors found to be particularly stain-conforming are black (including gray), blue, red, chino, green, and yellow, or substantial equivalents thereof, however, the spectrum of possible stain-conforming colors is not limited thereto. FIG. 2 defines the colors used herein in terms of exemplary ranges on the Pantoneg color scale. As there are other means and scales for defining colors, the colors and color combinations of the present invention are not limited to those defined by the Pantoneg color scale.

The dyed fabric is removed from the cotton dye bath where it is extracted, flat folded, and pre-dried in a relaxed state at 250 to 300 degrees at between about 25 percent and 30 percent overfeed to achieve a moisture content of between about 5 percent and 6 percent. The fabric is next taken to a conventional finishing range where one or more chemical finishes may be applied to the dyed fabric. For example, a modified glycol resin may be applied to provide shrinkage control. One suitable resin is Permafresh EFC Resin, available from Omnova Solutions, Inc. of Chester, S.C. A cationic softener may also be added. One suitable softener is Pomolube BFH, also available from Piedmont Chemical Industries. A silicone softener, such as Synthasil SWP30, and a wetting agent, such as Penetrant AME, both available from Piedmont Chemical Industries, may also be applied. As those skilled in the art will appreciate, the number and types of chemical finishes that are applied to the fabric will be dependent upon the properties and qualities that are desired in the final consumer product.

Once the chemical finishes have been applied to the dyed fabric, the fabric is dried in a finishing range (Step 130). While such ranges are conventionally known and used, the drying and curing are typically done in a single step at a single temperature that is high enough to cure the chemical finishes. Unlike the conventional single-step process, the method of the present invention requires a two-step, two-temperature, drying and curing process. As used herein, “drying” refers to the process of heating a fabric until the excess moisture is substantially removed. “Curing” refers to the process of fixing the dyes and chemical finishes in or to the fabric. The drying temperature of the present process should be between about 225 degrees Fahrenheit and 275 degrees Fahrenheit, and is desirably about 250 degrees Fahrenheit, to achieve between about 5 percent and 6 percent moisture content. This lower temperature allows for even drying of the chemicals, including the soil-release agent, without creating thermal migration that could drive the chemicals out of the internal fibers and up to the surface of the fibers. This also ensures consistency in chemical coverage throughout the fibers and ensures a more even cure and consistency during the curing stage.

After the fabric has been dried, the dried fabric is taken to a curing range (Step 140). While the process described herein is performed in two separate heating devices (finishing and curing), it could well be performed sequentially in the same range. Economies of operation will dictate the most suitable way to practice the drying and curing processes. The dried fabric is heated at a temperature between about 285 degrees Fahrenheit and 325 degrees Fahrenheit, and desirably at about 300 degrees Fahrenheit to achieve proper cure. At this temperature, the dyes and chemicals are finally cured and fixed. Further, this temperature provides sufficient heat to cure the resins, but not so much heat that the disperse dyes on the polyester become deteriorated. Also, because the fabric has already been dried before subjecting it to this curing temperature, less heat and time are required to accomplish the curing step. It has been found that this enhances the retention of the soil-release agent and chemical finishes.

Upon completion of the curing step, the fabric is essentially finished and may be mechanically treated, if desired, and packaged for subsequent processing where the fabric is cut and formed into garments (Step 150).

Fabric that has been dyed and finished in accordance with the method described hereinabove exhibits unexpected levels of soil-release and stain-concealment. The soil-release agent ensures that substantial portions of soil and discloration are removed from the fabric, or apparel, during home laundering. The more effective the soil-release, the less residual stain that will be present.

One widely adopted test that is designed to measure the ability of fabrics to release oily stains during home laundering is the American Association of Textile Chemists and Colorists (AATCC), Test Method 130-2000. AATCC Test Method 130-2000, Soil Release: Oily Stain Release Method, is a visual test used by fabric finishers to evaluate the likely performance of soil-release agents in actual use. In principle, an amount of a staining substance, such as a corn oil, is placed on a fabric sample and held under a cylindrical weight for a prescribed time. The stained fabric is then laundered in a prescribed manner and the residual stain rated on a scale of 1 to 5 by comparison with a stain release replica showing a graduated series of stains. The test method, incorporated by reference herein, prescribes the test equipment, staining procedure, washing procedure, and evaluation procedure for residual staining. While the AATCC 130-2000 test method uses only corn oil as a staining material, we have found that other equally relevant staining materials may, and should, be used for the purpose of determining the ability of finished fabrics and apparel to release the staining materials. For example, an equivalent amount of mustard or catsup can be dropped onto a fabric sample in the same fashion as prescribed in the AATCC test method. The sample is then washed and measured using the AATCC stain release replica. Similarly, it has been found that one teaspoon of a non-liquid staining material, such as animal fat, can be smeared onto a fabric sample and then washed and measured. As used herein, when samples are “measured” in accordance with the AATCC test method, this means that they AATCC stain release replica is used for measuring the residual staining, regardless of the staining material used.

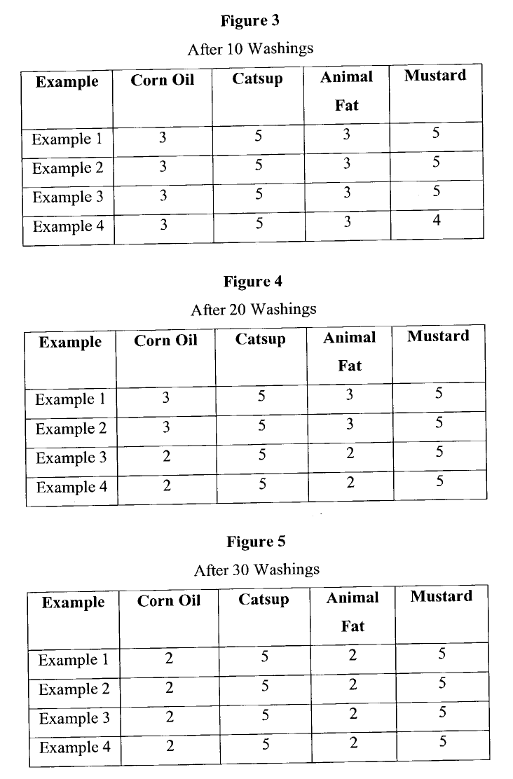

Turning now to FIGS. 3 through 7, the results of the AATCC 130-2000 testing are shown. On the grading scale, a 1 means that there is substantial residual staining, i.e., low soil release. A rating of 5, on the other hand, means that there is minimal residual staining, i.e., high level of soil-release. Each of the examples in FIGS. 3 through 7 correspond to the fabric constructions of Examples 1 through 4 described above. Each of the fabric samples was formed, dyed, and finished according to the present invention. Each of the fabric samples was cross-dyed with black and chino dyes. FIGS. 3 through 7 represent the measured AATCC rating after from between 10 additional washings and 50 additional washings. The purpose of measuring the samples after multiple washings is to determine the durability of the dyes and effectiveness of the soil-release agent. A “washing” is defined in the AATCC test method; however, the samples will be washed with a water temperature of at least about 120 degrees Fahrenheit, and also may be hang dried at room temperature (between about 70 and 80 degrees Fahrenheit).

As shown in FIG. 3, after 10 additional washings, the AATCC rating for each of the fabrics was at least 3. After 50 additional washings, the AATCC rating for each fabric sample was at least 2 for oil and animal fat, and at least 4 for mustard and catsup.

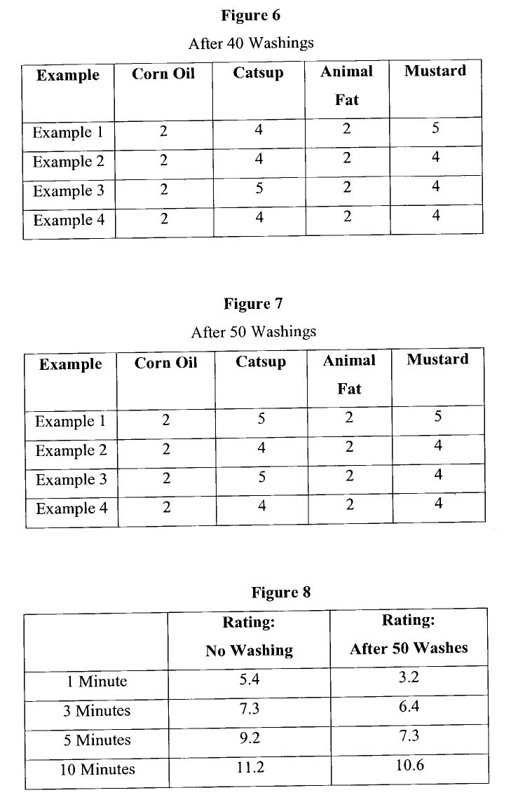

Because the soil release is a hydrophilic softener, a further aspect of the present invention is the high degree of wicking exhibited in articles of apparel constructed, dyed, and finished as described hereinabove. As used herein, “wicking” refers to the capillary action in a material whereby moisture is spread or dispersed through a given area, vertically or horizontally. The procedure measures the relative wicking of a fabric formed according to the present invention. A strip of fabric is cut to about 1 inch in width and 9 or more inches in length. One end of the strip is submerged in about 3 millimeters of de-ionized water at room temperature. The strip is vertical suspended from a stand. The test scale values in FIG. 8 indicate how many millimeters the water rises above the surface of the water into the strip within a specified number of minutes. As illustrated in FIG. 8, the results of vertical wicking measurements conducted in accordance with this method are shown for an unwashed fabric, or article or apparel, and the same fabric, or article of apparel, after 50 washings.

As shown in FIG. 8, the unwashed finished fabric exhibits a high level of wicking. In 1 minute, the unwashed fabric wicks about 5 millimeters and will wick to about 11 millimeters in 10 minutes. It has now been found that when the fabric or apparel of the present invention is tested after even 50 washings, the wicking is still significant. After 10 minutes, for example, wicking in the vertical test strip has diminished minimally after the 50 washings; i.e., after 10 minutes, the fabric wicks to 10.6 millimeters, or about 95 percent of the amount that the originally unwashed fabric wicked.

Although the present invention has been described with a preferred embodiment, it is to be understood that modifications and variations may be utilized without departing from the spirit and scope of the invention, as those skilled in the art will readily understand. Such modifications and variations are considered to be within the purview and scope of the appended claims and their equivalents.

We claim:

1. A method for forming a soil-resistant, stain-concealing, fabric, comprising:
cross-dyeing a fabric formed of natural and synthetic materials, or blends thereof, such that the natural and synthetic yarns are dyed with two colors, at least one color being a stain-conforming color;
applying a soil release agent to the fabric;
substantially drying, but not curing, the fabric at a first temperature; and
curing the knitted fabric at a second temperature.

2. The method of claim 1, wherein the fabric comprises at least about 60% by weight polyester.

3. The method of claim 1, wherein the fabric is formed from less than about 40% by weight cotton.

4. The method of claim 1, wherein the fabric is knitted.

5. The method of claim 4, wherein the knitted fabric is formed from the group consisting of a textured pique box stitch, a jersey stitch, 4×4 stripe stitch, and a herringbone stitch.

6. The method of claim 1, wherein the fabric is cross-dyed with a second stain-conforming color.

7. The method of claim 1, wherein the at least one stain-conforming color is substantially chino.

8. The method of claim 6, wherein the second stain-conforming color is substantially black.

9. The method of claim 1, wherein the at least one stain-conforming color is substantially red.

10. The method of claim 6 wherein the second stain-conforming color is substantially black.

11. The method of claim 1, wherein the at least one stain-conforming color is substantially yellow.

12. The method of claim 6, wherein the second stain-conforming color is substantially blue.

13. The method of claim 6, wherein the second stain-conforming color is substantially green.

14. The method of claim 1 wherein the stain release agent is applied during the dyeing of the fabric;

15. The method of claim 1, wherein the soil release agent is non-fluorchemical.

16. The method of claim 1 wherein the first temperature is between about 225 degrees Fahrenheit and 275 degrees Fahrenheit and is maintained until the moisture content of the fabric is between about 5 percent and 6 percent.

17. The method of claim 1 wherein the second temperature is between about 285 degrees Fahrenheit and 325 degrees Fahrenheit.

18. The method of claim 1 wherein the cross-dyed and treated fabric has a stain release value of at least about 2, after 50 washings, when measured according to the AATCC Test Method 130-2000 scale for visual stain appearance.

19. The method of claim 1 wherein the cross-dyed and treated fabric has a stain release value of at least about 3, after 10 washings, when measured according to the AATCC Test Method 130-2000 scale for visual stain appearance.

20. A soil-releasing, stain-concealing fabric, comprising:
(a) a fabric formed of natural and synthetic materials, or blends thereof; and
(b) the fabric is cross-dyed with two colors, at least one color being a stain-conforming color and treated with a soil release agent.

21. The fabric of claim 20, wherein the fabric comprises at least about 60% by weight polyester.

22. The fabric of claim 20, wherein the fabric is formed from less than about 40% by weight cotton.

23. The fabric of claim 20, wherein the fabric is knitted.

24. The fabric of claim 23 wherein the knitted fabric is formed from the group consisting of a textured pique box stitch, a jersey stitch, 4×4 stripe stitch, and a herringbone stitch.

25. The fabric of claim 20, wherein the fabric is cross-dyed with a second stain-conforming color.

26. The fabric of claim 23, wherein the at least one stain-conforming color is substantially chino.

27. The fabric of claim 25, wherein the second stain-conforming color is substantially black.

28. The fabric of claim 20, wherein the at least one stain-conforming color is substantially red.

29. The fabric of claim 25 wherein the second stain-conforming color is substantially black.

30. The fabric of claim 20, wherein the at least one stain-conforming color is substantially yellow.

31. The fabric of claim 25, wherein the second stain-conforming color is substantially blue.

32. The method of claim 25, wherein the second stain-conforming color is substantially green.

33. The fabric of claim 20 wherein the stain release agent is applied during the dyeing of the fabric;

34. The fabric of claim 20, wherein the soil release agent is non-fluorchemical.

35. The fabric of claim 20 wherein the cross-dyed and treated fabric has a stain release value of at least about 2, after 50 washings, when measured according to the AATCC Test Method 130-2000 scale for visual stain appearance.

36. The fabric of claim 20 wherein the cross-dyed and treated fabric has a stain release value of at least about 3, after 10 washings, when measured according to the AATCC Test Method 130-2000 scale for visual stain appearance.

37. Soil-releasing, stain-concealing apparel formed from a fabric comprising:
(a) natural and synthetic materials; and
(b) wherein the fabric is cross-dyed with two colors, at least one color being a stain-conforming color, and treated with a soil release agent.

38. The apparel of claim 37, wherein the fabric comprises at least about 60% by weight polyester.

39. The apparel of claim 37, wherein the fabric is formed from less than about 40% by weight cotton.

40. The apparel of claim 37, wherein the fabric is knitted.

41. The apparel of claim 40 wherein the knitted fabric is formed from the group consisting of a textured pique box stitch, a jersey stitch, 4×4 stripe stitch, and a herringbone stitch.

42. The apparel of claim 37, wherein the fabric is cross-dyed with a second stain-conforming color.

43. The apparel of claim 37, wherein the at least one stain-conforming color is substantially chino.

44. The apparel of claim 42, wherein the second stain-conforming color is substantially black.

45. The apparel of claim 37, wherein the at least one stain-conforming color is substantially red.

46. The apparel of claim 42, wherein the second stain-conforming color is substantially black.

47. The apparel of claim 37, wherein the at least one stain-conforming color is substantially yellow.

48. The apparel of claim 42, wherein the second stain-conforming color is substantially blue.

49. The apparel of claim 42, wherein the second stain-conforming color is substantially green.

50. The apparel of claim 37, wherein the stain release agent is applied during the dyeing of the fabric;

51. The apparel of claim 37, wherein the soil release agent is non-fluorchemical.

52. The apparel of claim 37 wherein the cross-dyed and treated fabric has a stain release value of at least about 2, after 50 washings, when measured according to the AATCC Test Method 130-2000 scale for visual stain appearance.

53. The apparel of claim 37 wherein the cross-dyed and treated fabric has a stain release value of at least about 3, after 10 washings, when measured according to the AATCC Test Method 130-2000 scale for visual stain appearance.
